(19) United States
(12) Patent Application Publication
(10) Pub. No.: US 2016/0068633 A1
(43) Pub. Date: Mar. 10, 2016

(54) METHODS AND SYSTEMS FOR THE RECOVERY OF WATER FROM A POLYAMIDE SYNTHESIS PROCESS

(71) Applicant: INVISTA NORTH AMERICA S.A.R.L., Wilmington, DE (US)

(72) Inventors: Thomas A. MICKA, McKinleyville, CA (US); Charles R. KELMAN, SR., Hixson, TN (US); John P. POINSATTE, Hixson, TN (US); Robert J. WELCH, Salisbury, MD (US); Gary R. WEST, Seaford, DE (US)

(73) Assignee: INVISTA NORTH AMERICA S.A R.L., WILMINGTON, DE (US)

(21) Appl. No.: 14/786,677

(22) PCT Filed: Apr. 15, 2014
(86) PCT No.: PCT/US2014/034086

§ 371 Date: Oct. 23, 2015

Related U.S. Application Data
(60) Provisional application No. 61/818,044, filed on May 1, 2013.

(51) Int. Cl. C08G 69/28; B01J 19/24

(52) U.S. Cl. CPC C08G 69/28; B01J 19/2415

(57) ABSTRACT

The present disclosure relates to systems and methods for recovering water from a condensation reaction of at least one carboxylic acid and at least one diamine to make polyamide. The method can include obtaining, from an evaporator, an aqueous mixture comprising a partially polymerized polyamide and at least one of a carboxylic acid and diamine; passing the aqueous mixture through a tubular reactor comprising subjecting the aqueous mixture to a temperature and pressure sufficient to further polymerize the partially polymerized polyamide by condensation of the carboxylic acid and diamine, thereby producing water having a substantially gaseous phase; passing the water having a substantially gaseous phase into a rectification column thereby removing one or more of a diamine, a carboxylic acid and polyamide to provide purified water having a substantially gaseous phase; and condensing the purified water having a substantially gaseous phase into purified water having a substantially liquid phase. The system can include, among other things, a tubular reactor, a rectification column, a condensation assembly, and a conduit network.

### CROSS-REFERENCE TO RELATED APPLICATION

This application claims the benefit of priority to U.S. Provisional Patent Application Ser. No. 61/818,044, filed May 1, 2013, the disclosure of which is incorporated herein in its entirety by reference.

### BACKGROUND

Polyamides are obtained via a process where a diamine (e.g., hexamethylene-1,6-diamine) and a dicarboxylic acid (e.g., adipic acid), sometimes in the form of ammonium carboxylate salt of the two components in water, are polymerized under condensation polymerization conditions (e.g., at temperatures ranging from 180° C. to 300° C.). The condensation reaction produces a polyamide (e.g., nylon 6,6) and water, as a byproduct. The water byproduct is produced at various stages of the polyamide synthesis process.

The polyamide synthesis process sometimes includes use of a tubular reactor. Such tubular reactors comprise vents located along the length of the reactor, where water produced during the polyamide synthesis process, in the form of water vapor, is allowed to escape. After being passed through a scrubber system, the water vapor that is vented is generally allowed to escape into the atmosphere or is condensed in the scrubber and passes to a waste water treatment process.

The disposal of water may be of little to no consequence in jurisdictions where there is no limit with regard to the amount of water that may be disposed into the local sewage system or where it is relatively cheap to dispose of water into the sewage system. But jurisdictions exist where there is a limit with regard to the amount of water that may be discarded and there are significant cost consequences associated with exceeding that limit. Additionally, the use of large volumes of demineralized water can present a significant cost. Accordingly, there is an ongoing need for methods and systems for recovering water from polyamide-producing facilities, especially in jurisdictions that impose significant cost consequences when the water disposal limit is exceeded.

### SUMMARY

It is problematic to discard water produced during the polyamide synthesis process, especially when it is in liquid form and could be recovered in purified form (e.g., in purified liquid form) and reused in the process in liquid form (e.g., to make up the diamine/dicarboxylic acid solution) or gaseous form (i.e., in the form of steam, where the steam may be used to transfer heat to one or more components of the polyamide synthesis process).

The present disclosure relates to systems and methods that address the problem of recovering water, in purified form, from a tubular reactor used in a polyamide synthesis process. The systems and methods described herein either reuse purified water, in liquid form, recovered from a tubular reactor used in the polyamide synthesis process or use water generated in a tubular reactor used in the polyamide synthesis process, in the form of steam, to transfer heat from the steam to one or more components of the polyamide synthesis process.

### DESCRIPTION OF THE DRAWINGS

In the drawings, like numerals can be used to describe similar elements throughout the several views. The drawings illustrate generally, by way of example, but not by way of limitation, various embodiments discussed in the present disclosure.

FIG. 1 is a schematic representation of a system for the manufacture of a polyamide.

FIG. 2 is a schematic representation of a tubular reactor (top view).

### DESCRIPTION

The present disclosure describes systems and methods for recovering water from a condensation reaction of at least one carboxylic acid and at least one diamine to make polyamide comprising: obtaining, from an evaporator, an aqueous mixture comprising a partially polymerized polyamide and at least one of a carboxylic acid and diamine; passing the aqueous mixture through a tubular reactor while subjecting the aqueous mixture to a temperature and pressure sufficient to further polymerize the partially polymerized polyamide by condensation of carboxylic acid and diamine, thereby producing water having a substantially gaseous phase; passing the water having a substantially gaseous phase into a rectification column thereby removing one or more of a diamine, a carboxylic acid and polyamide to provide purified water having a substantially gaseous phase; and condensing the purified water having a substantially gaseous phase into purified water having a substantially liquid phase.

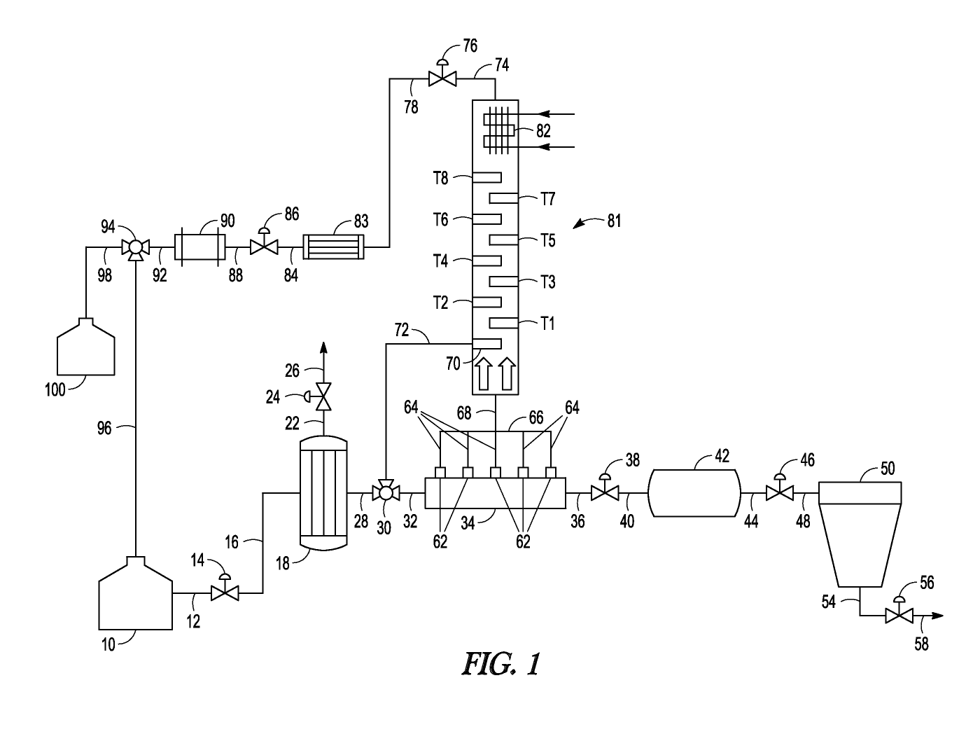

Making reference to FIG. 1, reservoir 10 (sometimes known as a “salt strike”) may contain an aqueous solution comprising a dicarboxylic acid, a diamine, and water having a substantially liquid phase. In some examples, the dicarboxylic acid and the diamine form a salt of the diamine and the dicarboxylic acid, such as an ammonium or diammonium salt, which may be dissolved in water having a reservoir 10. The reservoir 10 may be used to mix or store the aqueous solution. The type of reservoir contemplated for reservoir 10 is not limited and can be any suitable reservoir.

In one example, the aqueous solution may be routed via line 12, valve 14, and line 16 to an evaporator 18 where the aqueous solution may be concentrated by transforming a portion of the water having a substantially liquid phase (e.g., by heating at temperatures from about 100° C. to about 300° C.) to water having a substantially gaseous phase.

As used herein, the term “dicarboxylic acid” refers broadly to C₄-C₁₈ α,ω-dicarboxylic acids. Within this term are subsumed C₄-C₁₀ α,ω-dicarboxylic acids and C₄-C₈ α,ω-dicarboxylic acids. Examples of dicarboxylic acids encompassed by C₄-C₁₈ α,ω-dicarboxylic acids include, but are not limited to, succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), and sebacic acid (decanedioic acid). In some examples, the C₄-C₁₈ α,ω-dicarboxylic acid is adipic acid, pimelic acid or suberic acid. In still other examples, the C₄-C₁₈ α,ω-dicarboxylic acid is adipic acid.

As used herein, the term “diamine” refers broadly to C₄-C₁₈ α,ω-diamines. Within this term are subsumed C₄-C₁₀ α,ω-diamines and C₄-C₈ α,ω-diamines. Examples of diamines encompassed by C₄-C₁₈ α,ω-diamines include, but are not limited to, butane-1,4-diamine, pentane-1,5-diamine, and hexane-1,6-diamine, also known as hexamethylenediamine. In some examples, the C₄-C₁₈ α,ω-diamine is hexamethylenediamine.

In some examples, the use of adipic acid in combination with hexamethyelene diamine is contemplated herein.

As used herein, the term “polyamide” refers broadly to polyamides such as nylon 6, nylon 7, nylon 11, nylon 12, nylon 6,6, nylon 6,9; nylon 6,10, nylon 6,12, or copolymers thereof.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

In evaporator 18, the aqueous solution comprising the dicarboxylic acid and the diamine can be concentrated by transforming a portion of the water having a substantially liquid phase (e.g., by heating at temperatures from about 100° C. to about 300° C.) to water having a substantially gaseous phase. In the evaporator 18, the dicarboxylic acid and the diamine can also be partially reacted to form an aqueous mixture comprising a polyamide prepolymer (e.g., a polyamide that is not substantially completely polymerized).

In some instances, vent line 26 may receive at least some water having a substantially gaseous phase transferred by line 22 and valve 24. The vent line 26 may be in fluid communication with a scrubber system (not shown) or a suitable condenser (not shown), which can convert water having a substantially gaseous phase into water having a substantially liquid phase. A portion of the water having a substantially liquid phase can be transferred to a storage vessel (not shown) for, e.g., later use or discarded into the polyamide-producing facility's sewage system (not shown). In an embodiment, a portion of the water having a substantially liquid phase can be transferred to a storage vessel (not shown) for, e.g., later use; a portion can be discarded into the polyamide-producing facility's sewage system (not shown); and a portion can be reused (e.g., reused in the reservoir 10 or the tubular reactor 34). Reuse in the tubular reactor can include reuse as steam, such as for heat transfer.

As used herein, the term “polyamide prepolymer” refers broadly to unreacted dicarboxylic acid and diamine; to a polyamide that is not substantially completely polymerized (e.g., an oligomer); and to a mixture of unreacted dicarboxylic acid and diamine and polyamide that is not substantially completely polymerized (e.g., an oligomer). The polyamide prepolymer can be mostly or entirely comprised of the diamine/diacid salt or can be mostly or entirely comprised of polyamide, and need not include any substantial proportion, or any, of the diacid and diamine in their pure form.

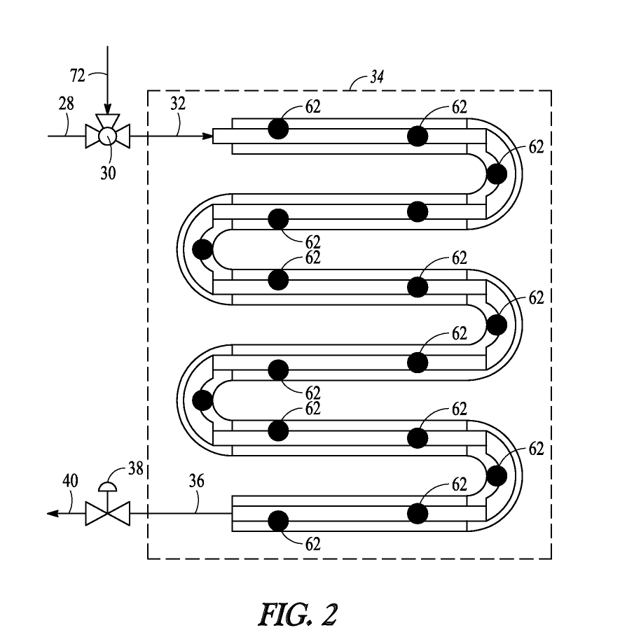

The aqueous mixture comprising a polyamide prepolymer may be transferred by line 28, valve 30, and line 32, to tubular reactor 34 (side view shown in FIG. 1 and top view shown in FIG. 2) where unreacted dicarboxylic acid and diamine may react further and form additional polyamide prepolymer.

In various examples, the reactor can heat the reaction mixture and evaporate water therefrom, pushing the equilibrium further toward a polyamide product. The reaction mixture can be heated to any suitable temperature within the reactor, such as about 150-400° C., or about 250-350° C., or about 250-310° C., or about 200° C. or less, or about 210° C., 220, 230, 240, 250, 260, 265, 270, 275, 280, 285, 290, 295, 300, 305, 310, 320, 330, 340° C., or about 350° C. or more. The reaction mixture exiting the reactor and passing to the flasher can have any suitable wt % water, such as about 0.000.1 wt % to 20 wt %, 0.001 to 15 wt %, or about 0.01 to 15 wt %, or about 0.000.1 wt % or less, or about 0.001 wt %, 0.01, 0.05, 0.06, 0.07, 0.08, 0.09, 0.1, 0.2, 0.3, 0.4, 0.5, 0.6, 0.7, 0.8, 0.9, 1.0, 1.2, 1.4, 1.6, 1.8, 2, 3, 4, 5, 6, 7, 8, 9, 10, 11, 12, 13, 14, 15, 16, 17, 18, 19 wt %, or about 20 wt % or more.

Making reference to FIG. 2, the tubular reactor 34 can be any suitable tubular reactor that can be used to further polymerize unreacted dicarboxylic acid, the diamine, and polyamide prepolymer to form additional polyamide prepolymer. The tubular reactor 34 can have any suitable shape and design. The tubular reactor 34 may include a cylindrical tube having a jacket disposed on the outside of the cylindrical tube.

The tubular reactor 34 can have any suitable length, such as the length between the inlet and outlet along the straight sections and curved sections. The tubular reactor 34 can have a length of about 50 to about 300 meters, about 75 to about 125 meters, or about 90 to about 110 meters, or about 50 meters or less, or about 60 meters, 70, 80, 85, 90, 95, 100, 105, 110, 115, 120, 130, 140, 150, 160, 170, 180, 190, 200, 225, 250, 275, or about 300 meters or greater.

The tubular reactor 34 can have any suitable inner diameter, such as of the straight and curved sections. The inner diameter can vary from one end of the reactor to the other, or the inner diameter can be constant. For example, the inner diameter can expand from the entrance of the tubular reactor to the exit of the tubular reactor. The tubular reactor 34 can have an inner diameter of about 10 cm to 80 cm, or about 25 cm to about 60 cm, or about 35 cm to 50 cm, or about 10 cm or less, or about 15 cm, 20, 25, 30, 35, 36, 37, 38, 39, 40, 41, 42, 43, 44, 45, 46, 47, 48, 49, 50, 55, 60, 65, 70, 75 cm, or about 80 cm or more. If the tubular reactor 34 includes a jacket, the jacket can have any suitable outer diameter, in some cases coincides with the outer diameter of the tubular reactor 34, such as about 1-50 cm beyond the inner diameter, or about 1 to 25 cm, or about 1 cm or less beyond the inner diameter, or about 2, 4, 6, 8, 10, 12, 14, 16, 18, 20, 22, 24, 26, 28, 30, 32, 34, 36, 38, 40, 42, 44, 46, 48, or about 50 cm or more beyond the inner diameter.

The tubular reactor can have a constant inner diameter, or the diameter can expand from the entrance to the exit of the reactor, such as a linear expansion, or a non-linear expansion. The diameter can expand sufficiently such that as the reactor is used substantially constant pressure is maintained from the entrance to the exit of the reactor. The diameter can expand such that as the reactor is used the pressure decreases from the entrance to the exit. The rate of expansion of the tubular reactor can be sufficient that that combination of heat applied to the reaction mixture, the amount of water removed from the reaction mixture through vaporization and venting, and the pressure of the reaction mixture at a given location along the length helps maintains a flow of the reaction mixture toward the exit of the reactor and reduces or minimizes the production or accumulation of gel or other impurities. The inner diameter of the reactor can expand about 2.5 cm per about 6.25 m to about 750 m of length, about 2.5 cm per about 22.5 m to about 550 m in length, about 2.5 cm per 22.5 m to about 110 m in length, or about 2.5 cm per about 6 m in length or less, or about 8 m, 10, 15, 20, 25, 30, 35, 40, 45, 50, 55, 60, 65, 70, 75, 80, 85, 90, 95, 100, 105, 110, 120, 125, 150, 175, 200, 225, 250, 275, 300, 325, 350, 375, 400, 425, 450, 475, 500, 525, 550, 600, 650, 700, or per about 750 m in length.

The tubular reactor 34 can have any suitable length/inner diameter (L/ID, e.g., length divided by the inner diameter of the tubular reactor). For example, the L/ID of the tubular reactor 34 can be about 50 to 2500, or about 100 to 500, or about 230 to 270, or about 50 or less, or about 75, 100, 125, 150, 175, 200, 210, 220, 230, 235, 240, 245, 250, 255, 260, 265, 270, 280, 290, 300, 400, 500, 600, 700, 800, 900, 1000, 1250, 1500, 1750, 2000, 2250, or about 2500 or more.

Making reference to FIGS. 1 and 2, the tubular reactor 34 includes one or more vents 62 along its length. The tubular reactor 34 can include any suitable number and type of vents 62, such that steam can be released from the vents 62. The tubular reactor 34 can include any suitable number of vents 62 along its length. For example, the tubular reactor 34 can have about 5 to 50 vents 62, or about 10 to 25 vents 62, along its length, or about 5 or less vents 62, or about 6, 7, 8, 9, 10, 11, 12, 13, 14, 15, 16, 17, 18, 19, 20, 21, 22, 23, 24, 25, 30, 35, about 45 vents 62, or about 50 or more vents 62 along its length.

A vent 62 can be present in the tubular reactor 34 at any suitable average range of distance away from an adjacent vent 62. For example, the tubular reactor 34 can have an average of about 1 vent 62 every about 2 meters to about 15 meters along the length of the tubular reactor 34, every about 3 meters to about 9 meters, or every about 5 to about 8 meters along the length of the tubular reactor 34, or about 1 vent 62 every about 2 or less meters, or about every 3 meters, 4, 5, 6, 7, 8, 9, 10, 11, 12, 13, 14, or about 15 or more meters, along the length of the tubular reactor 34.

The tubular reactor 34 can have any suitable amount of average spacing between vents 62 along its length. For example, the vents 62 can be spaced an average of about 2 meters to about 15 meters apart along the length of the tubular reactor 34, about 3 meters to about 9 meters, or can be spaced an average of about 5 to about 8 meters along the length of the tubular reactor 34, or an average of about 2 meters or less, or an average of about 3 meters, 4, 5, 6, 7, 8, 9, 10, 11, 12, 13, 14, or an average of about 15 or more meters, along the length of the tubular reactor 34.

The tubular reactor 34 can have a number and distribution of vents 62 such that the velocity of water having a substantially gaseous phase within the tubular reactor 34 does not exceed any suitable maximum. For example, the number and distribution of vents 62 can be sufficient so that a velocity of steam within the tubular reactor 34 does not exceed about 0.5 m/s to about 400 m/s, 1-200 m/s, 2-100 m/s, 4-50 m/s, or about 0.5 m/s or less, or about 1 m/s, 2, 3, 4, 5, 15, 10, 20, 25, 30, 35, 40, 45, 50, 55, 60, 65, 70, 75, 80, 85, 90, 95, 100, 125, 150, 175, 200, 250, 300 m/s, or about 400 m/s or more.

The tubular reactor can have any suitable flowrate of polymer material therethrough. For example, the flowrate can be 1 L/min to about 1,000,000 L/min, or about 10 L/min to about 100,000 L/min, or about 1 L/min or less, 10 L/min, 20, 30, 40, 50, 60, 70, 80, 90, 100, 125, 150, 175, 200, 225, 250, 275, 300, 350, 400, 450, 500, 600, 700, 800, 900, 1,000, 2,500, 5,000, 10,000, 50,000, 100,000, 500,000, or about 1,000,000 L/min or more. The polymerization system including the tubular reactor can generate polymer at any suitable rate, such as about 1 L/min to about 1,000,000 L/min, or about 10 L/min to about 100,000 L/min, or about 1 L/min or less, 10 L/min, 20, 30, 40, 50, 60, 70, 80, 90, 100, 125, 150, 175, 200, 225, 250, 275, 300, 350, 400, 450, 500, 600, 700, 800, 900, 1,000, 2,500, 5,000, 10,000, 50,000, 100,000, 500,000, or about 1,000,000 L/min or more.

The tubular reactor 34 can have a number and distribution of vents 62 such that the tubular reactor 34 has any suitable F-factor. The vents 62 can be connected to suitable vent lines. The method can include injecting water into the vent line. Water can be injected into each vent at any suitable rate.

The tubular reactor of the present invention can operate for any suitable time between shutdown and cleaning to remove gel or other contaminants. For example, the method can be performed without shutting down the tubular reactor for cleaning for at least about 1 to 7 years, 2 to 5 years, or about 2.3 to 3 years, or about 3 years.

The tubular reactor can have any suitable flow regime of reaction mixture and steam therein. For example, the tubular reactor can have predominantly annular flow (e.g., the majority of the liquid is in contact with the inside of the reactor tube, while the gases and steam predominantly travel down the middle of the reactor tube). In some examples, the tubular reactor can have slug flow (e.g. a substantially continuous cylinder of liquid in the tube interspersed with a substantially continuous cylinder of gas and steam in the tube), and other flow regimes (e.g., the liquid stays at the bottom of the tube forming an approximate half-cylinder while the gas and steam stay at the top of the tube). Any suitable combination of annular flow, slug flow, and other flow regimes can occur in the tubular reactor.

In the non-limiting example shown in FIG. 1, the vents 62 on tubular reactor 34 are connected to one or more lines 64 that may be a part of a manifold 66 that can communicate to one or more lines 68. The one or more lines 68 may be connected to one or more rectification columns 80 (only one shown in FIG. 1) comprising one or more rectifying zones 81. In an embodiment, each of the one or more lines 64 may directly connect to line 68 (a configuration not shown in FIG. 1). In an embodiment, line 68 may be absent and each of the one or more lines 64 may directly connect to rectification column 80 (a configuration not shown in FIG. 1).

The rectification column 80 may be any suitable rectification column. See, e.g., U.S. Pat. No. 3,900,450, which is incorporated by reference in its entirety herein. The water having a substantially gaseous phase can flow into a rectification column 80, which, in the non-limiting example shown in FIG. 1, comprises eight trays T1-T8. The trays T1-T8 may be, for example, bubble cap trays or sieve plate trays and may number more or less than eight. Those of skill in the art will appreciate that the trays T1-T8 may be replaced with any suitable column packing including glass wool, Raschig rings, glass beads, structured packing, or any suitable column packing material. The column can have any suitable height, such as about 1 M to about 500 M, or about 1 M to about 20 M, or about 1 M or less, or about 2 M, 3, 4, 5, 6, 7, 8, 9, 10, 12, 14, 16, 18, 20, 25, 30, 35, 40, 45, 50, 100, 150, or about 200 M or more. The column can have any suitable diameter, such as about 0.1 M to about 30 M, or about 0.1 M to about 10 M, or about 0.1 M or less, or about 0.5 M, 1, 2, 3, 4, 5, 6, 7, 8, 9, 10, 12, 14, 16, 18, 20, 22, 24, 26, 28, or about 30 M.

The water having a substantially gaseous phase rises from the bottom of the rectification column 80 and passes through the rectifying zone 81. The water having a substantially gaseous phase rising from the top tray, here denoted as tray T8, contacts a partial condenser-preheater 82 and may be partially condensed to produce reflux. The quantity of reflux returned to the rectification column 80 from the partial condenser-preheater 82 may be governed by, among other things, the amount, concentration and temperature of at least the fluid (e.g., aqueous solution comprising a dicarboxylic acid, a diamine, and water having a substantially liquid phase that may flow through the condenser-preheater coils for the purpose of preheating it) entering partial condenser-preheater 82; and the pressure in the rectifying zone 81. The heat transfer area of the partial condenser-preheater 82 may, in one example, be configured so that an increase in the flow of fluid therein increases the amount of water having a substantially gaseous phase condensed as reflux. In some examples, water having a substantially liquid phase that may collect at the bottom of the rectification column 80 may be heated using any suitable means to convert it into water having a substantially gaseous phase, thereby producing at least some reflux.

As the water having a substantially gaseous phase passes through a rectifying zone 81, one or more of a diamine, a carboxylic acid and polyamide collect in reservoir 70 in the form of a substantially aqueous solution thereof. The substantially aqueous solution comprising the one or more of a diamine, a carboxylic acid and polyamide may then be recirculated, in some examples, by line 72, valve 30, and line 32 into tubular reactor 34 to be reused in the polyamide synthesis process. In one example, the one or more of a diamine, a carboxylic acid and polyamide can be collected in reservoir 70 in the form a substantially aqueous solution thereof. The solution can be transferred to one or more components of a polyamide synthesis process including, without limitation, reservoir 10 or evaporator 18 via a line or valve network (not shown in FIG. 1). In some instances, reservoir 70 may be located where T2, T4 or T6 are located (a configuration not shown in FIG. 1). In some instances, there can be more than one reservoir 70 inside the rectification column. In some instances, dicarboxylic acid may be added (e.g., via injection) to reservoir 70 or to a higher tray in the column to react, e.g., with diamine, such as hexamethylene diamine. The material resulting from the reaction of the dicarboxylic acid and the diamine (e.g., polyamide prepolymer) can then be recirculated, e.g., back to reactor 34 by line 72, valve 30, and line 32.

The uncondensed water having a substantially gaseous phase that may be vented from the top of rectification column 80, through the vent line 74 and valve 76, can constitute purified water having a substantially gaseous phase. The purified water having a substantially gaseous phase may be transferred to condenser 83 by line 78 where it may be condensed into water having a substantially liquid phase. The water having a substantially liquid phase may then be transferred by line 84, valve 86, and line 88. In some embodiments, the water can be transferred to to a filter or absorption assembly 90, as shown in FIG. 1. In some embodiments, the water having a substantially liquid phase can be used directly for steam or can be recycled upstream without further purification (not shown in FIG. 1). The water that exits the column 80 at line 74 can include at least one of the water having a substantially gaseous phase, the purified water having a substantially gaseous phase, the purified water having a substantially liquid phase, or a combination thereof). The water that emerges in line 74 can be substantially demineralized, which can allow for reduced consumption of fresh demineralized water if introduced back into the process, resulting in cost savings.

In addition to removing one or more of a diamine, a carboxylic acid and polyamide, the rectification column can remove one or more impurities from the water having a substantially gaseous phase such as at least one of a gelation-causing material and a polyamide-degrading material. The separated impurity can be a solid (undissolved) impurity like a heavy metal. Heavy metals not soluble in water or minimally soluble in water can flow with the water having a substantially gaseous phase into the recycle apparatus in the form of water droplets containing suspended material therein. Certain heavy metals, such as iron, cobalt, manganese, magnesium, and titanium, and inorganic materials such as silica, can catalyze the formation of gel, including by catalyzing the formation of bis(hexamethylene)triamine. The separated impurity can have a boiling point that differs from that of water, such as cyclopentanone (BP=131° C.), hexamethyleneimine (BP=138° C.), or bis(hexamethylene)triamine (BP=163-164° C.). Cyclopentanone, hexamethyleneimine, bis(hexamethylene)triamine can act as end-capping agents (e.g., prematurely terminating polymerization at one or more ends of the polymer), branching agents (e.g., causing polymer strands to loose linearity, which can form gel), and as linear units in the final polyamide product (e.g., which can upset the regular repeating unit of the polyamide, degrading product quality). The water that emerges from the rectification column can be suitably free of one or more gelation-causing materials or polyamide-degrading materials such that high water recycle ratios can be achieved without the build-up of gelation-causing materials or polyamide-degrading materials.

The filteration or absorption assembly 90 can purify the water having a substantially liquid phase by removing impurities (e.g., gelation-causing materials or polyamide-degrading materials) from the water having a substantially liquid phase. A representative filter or absorption assembly 90 may be in any suitable configuration and may comprise a coarse filter (e.g., 200 μm) and, optionally, a heat exchanger, both of which may be in line with a first fine filter (e.g., 50 μm). The first fine filter may be in any suitable configuration, including in-line with at least one activated carbon sorbent bed. The water having a substantially liquid phase can then pass through a second fine filter (e.g., 5 μm) to remove particulate matter that may escape the sorbent bed, including activated carbon sorbent. Examples of impurities that can be removed using the filter or absorption assembly 90 include heavy metals such as iron, cobalt, manganese, magnesium, and titanium, and can include organic materials such as cyclopentanone, hexamethyleneimine, bis(hexamethylene)triamine, and inorganic materials such as silica.

In various embodiments, line 74 can be a side draw from rectification column 80, rather than the top stream illustrated in FIG. 1. The side draw can carry the water having a substantially gaseous phase, the purified water having a substantially gaseous phase, the purified water having a substantially liquid phase, or a combination thereof. Materials having a lower boiling point than water can emerge from the top of the column. In some embodiments, the column can have a bottoms stream exiting the lower portion of the column that can contain materials having a higher boiling point than water (e.g., at least one of adipic acid, hexamethylenediamine, cyclopentanone, hexamethyleneimine, and bis(hexamethylene)triamine). The bottoms stream can carry solid impurities, such as iron, cobalt, titanium, manganese, magnesium, and silica. In some embodiments, the bottom stream can return reactants to the reactor 34 or to evaporator 18, optionally first passing through a filter assembly similar to unit 98 to remove solid impurities.

In some embodiments, the column can have a side draw below the height that line 74 is drawn from the column (as a top draw or side draw) and above the bottom of the column, such that materials having intermediate boiling points can be removed from the system. For example, in some embodiments, the column can include a bottoms stream that includes materials such as at least one of solid impurities, adipic acid, and hexamethylenediamine, a first side draw that includes at least one of cyclopentanone, hexamethyleneimine, and bis(hexamethylene)triamine, and a top draw or a second side draw above the first side draw that carries at least one of the water having a substantially gaseous phase, the purified water having a substantially gaseous phase, the purified water having a substantially liquid phase.

The water having a substantially liquid phase may be reused, for example, by returning the purified water having a substantially liquid phase to one or more components of a polyamide synthesis process including, without limitation, reservoir 10 by line 92, valve 94, and line 96. In an embodiment, the purified water having a substantially liquid phase may be transferred to a storage vessel 100 by line 92, valve 94, and line 98 for, e.g., later use. In an embodiment, the water having a substantially liquid phase may be transferred from condenser 83, or from filter or absorption assembly 90, into a polyamide-producing facility's sewage system (not shown). In one example, a portion of the water having a substantially liquid phase can be transferred to a storage vessel 100 for, e.g., later use; a portion can be discarded into the polyamide-producing facility's sewage system (not shown); and a portion can be reused by routing it to one or more components of a polyamide synthesis process (e.g., reused in one or more of the reservoir 10, evaporator 18, reactor 34, flasher 42, finisher 50 or storage vessel 100). In various embodiments, reusing the water having a substantially liquid phase can include transforming the water into steam and using the steam in one or more components of the polyamide synthesis process.

In some examples, the emerging from rectification column 80 in line 74 (e.g., the water having a substantially gaseous phase, the purified water having a substantially gaseous phase, the purified water having a substantially liquid phase, or a combination thereof) or that exits the absorption or filtration apparatus is sufficiently pure to be used as a source of steam in the polyamide synthesis process, e.g., at least about 90 wt % pure, or about 91 wt %, 92, 93, 94, 95, 96, 97, 98, 99, 99.9, 99.99, 99.999, 99.999,9, 99.999,99, or about 99.999,999 wt % or more pure. In some embodiments, the steam has sufficient purity to be used to drive a vacuum steam ejector to draw a vacuum on the downstream finisher with reliable operation.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of heavy metals (e.g., elemental heavy metals or compounds including heavy metals), such as about 1 wt % or less, or about 0.5 wt %, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the rectification column or the filter or absorption assembly can have any suitable reduction in the total amount of heavy metals, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of iron (e.g., elemental iron or compounds including iron), such as about 1 wt % or less, or about 0.5 wt %, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the rectification column or the filter or absorption assembly can have any suitable reduction in the total amount of iron, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of cobalt (e.g., elemental cobalt or compounds including cobalt), such as about 1 wt % or less, or about 0.5 wt %, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the rectification column or the filter or absorption assembly can have any suitable reduction in the total amount of cobalt, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of manganese (e.g., elemental manganese or compounds including manganese), such as about 1 wt % or less, or about 0.5 wt %, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the rectification column or the filter or absorption assembly can have any suitable reduction in the total amount of manganese, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of magnesium (e.g., elemental magnesium or compounds including magnesium), such as about 1 wt % or less, or about 0.5 wt %, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the rectification column or the filter or absorption assembly can have any suitable reduction in the total amount of magnesium, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of titanium (e.g., elemental titanium or compounds including titanium), such as about 1 wt % or less, or about 0.5 wt %, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the rectification column or the filter or absorption assembly can have any suitable reduction in the total amount of titanium, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of silica, such as about 1 wt % or less, or about 0.5 wt %, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the rectification column or the filter or absorption assembly can have any suitable reduction in the total amount of silica, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of cyclopentanone, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the filter or absorption assembly or the water that emerges from the rectification column can have any suitable reduction in the amount of the cyclopentanone, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of hexamethyleneimine, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the filter or absorption assembly or the water that emerges from the rectification column can have any suitable reduction in the amount of the hexamethyleneimine, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of bis(hexamethylene)triamine, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the filter or absorption assembly or the water that emerges from the rectification column can have any suitable reduction in the amount of the bis(hexamethylene)triamine, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of hexamethylenediamine, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the filter or absorption assembly or the water that emerges from the rectification column can have any suitable reduction in the amount of the hexamethylenediamine, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

The water that emerges from the rectification column (e.g., the water having a substantially gaseous phase, the purified water having a substantially gaseous phase, the purified water having a substantially liquid phase, or a combination thereof) or that emerges from the filter or absorption assembly can have any suitable concentration of adipic acid, such as about 10 wt % or less, or about 5 wt %, 4.5, 4, 3.5, 3, 2.5, 2, 1.5, 1, 0.5, 0.1, 0.05, 0.01 wt % or less, about 1 ppb to about 10,000 ppm, about 10 ppb to about 1,000 ppm, about 100 ppb to about 100 ppm, or about 5,000 ppm or more, about 1,000 ppm, 500 ppm, 100 ppm, 50 ppm, 10 ppm, 5 ppm, 1 ppm, 500 ppb, 100 ppb, 50 ppb, 10 ppb, 5 ppb, or about 1 ppb or less. As compared to the water that exits the reactor and enters the recycle assembly, the water that emerges from the filter or absorption assembly or the water that emerges from the rectification column can have any suitable reduction in the amount of the adipic acid, such as about 1% to about 100% reduction, or about 50 to about 99% reduction, or about 10%, 20, 30, 40, 50, 60, 70, 80, 90, 95, 96, 97, 98, 99, 99.9, 99.99, or about 99.999 wt % reduction or more.

Regardless of how the water having a substantially liquid phase or the water having a substantially gaseous phase are ultimately reused (e.g., reused in the reservoir 10, tubular reactor 34 or stored in storage vessel 100), the methods and systems described herein condense at least 80% or less of the purified water having a substantially gaseous phase that exits rectification column 80 into water having a substantially liquid phase. In some cases, at least 85%, at least 90%, at least 95%, at least 99%, from about 80% to about 100%, from about 80% to about 90%, from about 85% to about 95%, from about 90% to about 99% or about 100% of the water having a substantially gaseous phase that exits rectification column 80 may be condensed into water having a substantially liquid phase.

In some examples, the methods and systems described herein further comprise operating at a water recycle ratio of at least 0.2:1, v/v. As used herein, the term “recycle ratio” refers broadly to the volume ratio of liquid water that is reused/recycled to the reservoir relative to the volume of “fresh” liquid water (i.e., water that comes from a source other than from condensing the water having a substantially gaseous phase into water having a substantially liquid phase) used to make, among other things, the aqueous solution contained in reservoir 10. In some examples, the water recycle ratio can be at least 0.2:1 or less, or about 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2:1, 2.2:1, 2.4:1, 2.6:1, 2.8:1, 3:1, 3.5:1, 4:1, 4.5:1, 5:1, 6:1, 7:1, 8:1, 9:1; 20:1; 50:1, 100:1, or about 200:1 or more. In other examples, the water recycle ratios range from about 1:1 to about 200:1, e.g., from about 10:1 to about 100:1 or from about 25:1 to about 100:1.

In some examples, the one or more of the lines and valves mentioned herein, including those used to route the water having a substantially gaseous phase (e.g., line 74, valve 76, and line 78) and the water having a substantially liquid phase (e.g., line 84, valve 86, line 88, line 92, valve 94, line 96, and line 98), are made of stainless steel or other material that helps maintain, reduce or minimize the level of impurities such as gelation-causing materials and polyamide-degrading materials in at least the substantially purified water having a substantially liquid phase.

As used herein, the term “iron” refers broadly to iron ions (e.g., in solution as Fe³⁺ and Fe²⁺ ions), elemental iron, and iron oxides (e.g., FeO, Fe₂O₃, and Fe₃O₄), and compounds of iron.

As used herein, the term “cobalt” refers broadly to cobalt ions (e.g., in solution as Co³⁺ and Co²⁺ ions), elemental cobalt, and compounds of cobalt that may act as gelation catalysts.

As used herein, the term “manganese” refers broadly to manganese ions, elemental manganese, and compounds of manganese that may act as gelation catalysts.

As used herein the term “magnesium” refers broadly to magnesium ions, elemental magnesium, and compounds of magnesium that may act as gelation catalysts.

As used herein, the term “titanium” refers broadly to titanium ions, elemental titanium, and compounds of titanium that may act as geleation catalysts.

Polyamide prepolymer that is formed in tubular reactor 34 may be routed by line 36, valve 38, and line 40 to flasher 42. The flasher 42, in turn, may be in fluid communication with finisher 50 by line 44, valve 46, and line 48. The finisher 50 can, in turn, be in fluid communication with line 54, valve 56, and line 58, through which a substantially polymerized polyamide may be transferred for further processing (e.g., spinning or pelletization).

### Examples

Continuous polymerization process. The following process is performed in the Examples. In a continuous nylon 6,6 manufacturing process, adipic acid and hexamethylenediamine are combined in a salt strike in an approximately equimolar ratio in water to form an aqueous mixture containing nylon 6,6 salt and having about 50 wt % water. The aqueous salt is transferred to an evaporator at approximately 105 L/min. The evaporator heats the aqueous salt to about 125-135° C. (130° C.) and removes water from the heated aqueous salt, bringing the water concentration to about 30 wt %. The evaporated salt mixture is transferred to a tubular reactor at approximately 75 L/min. The tubular reactor has a length of about 100 meters and an average inner diameter of about 40.6 cm, an expansion rate of inner diameter from entrance to exit of about 2.5 cm per every 50 m length, with an L/D ratio of about 246, and with 17 vents distributed along the length. The reactor raises the temperature of the evaporated salt mixture to about 218-250° C. (235° C.), allowing the reactor to further remove water from the heated evaporated salt mixture, bringing the water concentration to about 10 wt %, and causing the salt to further polymerize. The reacted mixture is transferred to a flasher at approximately 60 L/min. The flasher heats the reacted mixture to about 270-290° C. (285° C.) to further remove water from the reacted mixture, bringing the water concentration to about 0.5 wt %, and causing the reacted mixture to further polymerize. The flashed mixture, having a relative viscosity of about 13, is transferred to a finisher at approximately 59 L/min. In the transfer piping between the flasher and the finisher, the polymer mixture maintains a temperature of about 285° C. The finisher subjects the polymeric mixture to a vacuum to further remove water, bringing the water concentration to about 0.1 wt % and the relative viscosity to about 60, such that the polyamide achieves a suitable final range of degree of polymerization before transferring the finished polymeric mixture to an extruder and a pelletizer at about 59 L/min.

General Method for Determination of Gelation Rate.

Each gelation rate described in the Examples is determined by taking an average of the gelation rate as determined by two methods. In the first method, while the reaction mixture is still hot the system is drained of the liquid reaction mixture, the system is cooled, diassembled, and visually inspected to estimate the volume of gel therein. In the second method, while the reaction mixture is still hot the system is drained of liquid reaction mixture, cooled, filled with water, and drained of the water. The volume of water drained from the system is subtracted from the gel-free volume of the system to determine the volume of gel in the system. For determination of gelation rates in one or more specific pieces of equipment or downstream of a particular location, only the specific pieces of equipment or the system downstream of the particular location is filled with water. In both methods, the density of the gel is estimated at 0.9 g/cm³.

The variable X is a constant value throughout the Examples. Rectification columns have side or bottom draws for at least partial separation of solid impurities and materials having lower boiling points than water.

### Example 1

### Comparative. No Removal of Impurities from Recycle Water, No Heat Integration

The continuous polymerization process is performed. The vaporous material evaporated from the reaction mixture in the reactor exits the vents of the reactor and is condensed without further purification. Condensing 18.5 Kg/min of 235° C. steam into 18.5 L/min of aqueous 90° C. liquid requires about 48 MJ/min. Approximately 18.5 L/min of condensed unpurified water from the reactor is recycled back to the salt strike. The tubular reactor recycle apparatus and associated transfer piping is primarily stainless steel. After 3-months online, the purified water recycled to the salt strike contains about 100 ppm iron, about 50 ppm cobalt, about 10,000 ppm cyclopentanone, about 8,000 ppm hexamethyleneimine, about 5,000 ppm bis(hexamethylene)diamine, about 100,000 ppm hexamethylenediamine, and about 1,000 ppm adipic acid. Finished polyamide pellets generated by the system have a yellowness index measured in accordance with ASTM D1925 of about 4. The total amount of recycled water entering the salt strike is 18.5 L/min, which is combined with 37.5 L/min of demineralized fresh water, with a recycle ratio of 0.5:1.

Approximately 1 Kg/day of gel is generated in the continuous polymerization system. The reactor recycle apparatus costs about X/day to operate, plus the cost of condensing the steam of about 15.5*X/day. As compared to a corresponding process having no evaporator recycle, avoiding excess sewer discharge fines and using less demineralized fresh water saves about 30*X per day.

### Example 2

### Comparative. No Removal of Impurities from Recycle Water, Carbon Steel Evaporator Recycle Apparatus, No Heat Integration

The continuous polymerization process is performed. The vaporous material evaporated from the reaction mixture in the reactor exits the vents of the reactor and is condensed without further purification. Condensing 18.5 Kg/min of 235° C. steam into 18.5 L/min of aqueous 90° C. liquid requires about 48 MJ/min. Approximately 18.5 L/min of condensed unpurified water from the reactor is recycled back to the salt strike. The tubular reactor recycle apparatus and associated transfer piping is primarily carbon steel. After 3-months online, the purified water recycled to the salt strike contains about 10,000 ppm iron, about 5,000 ppm cobalt, about 20,000 ppm cyclopentanone, about 16,000 ppm hexamethyleneimine, about 10,000 ppm bis(hexamethylene)diamine, about 100,000 ppm hexamethylenediamine, and about 1,000 ppm adipic acid. Finished polyamide pellets generated by the system have a yellowness index measured in accordance with ASTM D1925 of about 5. The total amount of recycled water entering the salt strike is 18.5 L/min, which is combined with 37.5 L/min of demineralized fresh water, with a recycle ratio of 0.5:1.

Approximately 2 Kg/day of gel is generated in the continuous polymerization system. The reactor recycle apparatus costs about X/day to operate, plus the cost of condensing the steam of about 15.5*X/day. As compared to a corresponding process having no evaporator recycle, avoiding excess sewer discharge fines and using less demineralized fresh water saves about 30*X per day.

### Example 3

### Comparative. No Removal of Impurities from Recycle Water, Corrosion Control-Treated Carbon Steel Evaporator Recycle Apparatus, No Heat Integration

The continuous polymerization process is performed. The vaporous material evaporated from the reaction mixture in the reactor exits the vents of the reactor and is condensed without further purification. Condensing 18.5 Kg/min of 235° C. steam into 18.5 L/min of aqueous 90° C. liquid requires about 48 MJ/min. Approximately 18.5 L/min of condensed unpurified water from the reactor is recycled back to the salt strike. The tubular reactor recycle apparatus and associated transfer piping is primarily carbon steel that has been treated with a combination of sodium dihydrogen orthophosphate, sodium benzoate, sodium nitrite, and sodium nitrate. After 3-months online, the purified water recycled to the salt strike contains about 100 ppm iron, about 50 ppm cobalt, about 10,000 ppm cyclopentanone, about 8,000 ppm hexamethyleneimine, about 5,000 ppm bis(hexamethylene)diamine, about 100,000 ppm hexamethylenediamine, and about 1,000 ppm adipic acid. Finished polyamide pellets generated by the system have a yellowness index measured in accordance with ASTM D1925 of about 4. The total amount of recycled water entering the salt strike is 18.5 L/min, which is combined with 37.5 L/min of demineralized fresh water, with a recycle ratio of 0.5:1.

Approximately 1 Kg/day of gel is generated in the continuous polymerization system. The reactor recycle apparatus costs about X/day to operate, plus the cost of condensing the steam of about 15.5*X/day. As compared to a corresponding process having no evaporator recycle, avoiding excess sewer discharge fines and using less demineralized fresh water saves about 30*X per day.

However, over a period of about 6 months, the corrosion-control materials leach out of the carbon steel, partially losing their corrosion-controlling effect and contaminating the polyamide product. After six months online, the purified water recycled to the salt strike contains about 10,000 ppm iron, about 5,000 ppm cobalt, about 20,000 ppm cyclopentanone, about 16,000 ppm hexamethyleneimine, about 10,000 ppm bis(hexamethylene)diamine, about 100,000 ppm hexamethylenediamine, and about 1,000 ppm adipic acid. Finished polyamide pellets generated by the system have a yellowness index measured in accordance with ASTM D1925 of about 5. After 6 months, the gel formation rate in the system is about 1.5 Kg/day.

### Example 4

### Comparative. Selective but Inadequate Removal of Some Impurities from Recycle Water with Filtration, No Heat Integration

The continuous polymerization process is performed. The vaporous material evaporated from the reaction mixture in the reactor exits the vents of the reactor and is condensed. Condensing 18.5 Kg/min of 235° C. steam into 18.5 L/min of aqueous 90° C. liquid requires about 48 MJ/min. The condensed water cleaned by passing through a filter assembly containing a coarse filter (200 μm) in line with a first fine filter (50 μm). The first fine filter is in line with an activated carbon sorbent bed containing about 50 Kg of activated carbon sorbent. The water then passes through a second fine filter (5 μm). Approximately 18.5 L/min of condensed cleaned water from the reactor is recycled back to the salt strike. The tubular reactor recycle apparatus and associated transfer piping is primarily stainless steel. After 3-months online, the purified water recycled to the salt strike contains about 50 ppm iron, about 25 ppm cobalt, about 8,000 ppm cyclopentanone, about 7,000 ppm hexamethyleneimine, about 4,000 ppm bis(hexamethylene)diamine, about 100,000 ppm hexamethylenediamine, and about 1,000 ppm adipic acid. Finished polyamide pellets generated by the system have a yellowness index measured in accordance with ASTM D1925 of about 3.5. The total amount of recycled water entering the salt strike is 18.5 L/min, which is combined with 37.5 L/min of demineralized fresh water, with a recycle ratio of 0.5:1.

Approximately 1 Kg/day of gel is generated in the continuous polymerization system. The reactor recycle apparatus costs about 3*X/day to operate, plus the cost of condensing the steam of about 15.5*X/day. As compared to a corresponding process having no evaporator recycle, avoiding excess sewer discharge fines and using less demineralized fresh water saves about 30*X per day.

### Example 5

### Comparative. Selective but Inadequate Removal of Impurities from Recycle Water with Rectification, No Heat Integration

The continuous polymerization process is performed. The vaporous material evaporated from the reaction mixture in the reactor exits the vents of the reactor and is directed to a 1 M tall 0.5 M diameter rectification column packed with Raschig rings. The vapour that exits the top of the column is condensed into liquid for recycling. Condensing 18.5 Kg/min of 100° C. steam into 18.5 L/min of aqueous 90° C. liquid requires about 43 MJ/min. Approximately 18.5 L/min of condensed water from the reactor is recycled back to the salt strike. The tubular reactor recycle apparatus and associated transfer piping is primarily stainless steel. After 3-months online, the purified water recycled to the salt strike contains about 35 ppm iron, about 15 ppm cobalt, about 5,000 ppm cyclopentanone, about 4,000 ppm hexamethyleneimine, about 2,000 ppm bis(hexamethylene)diamine, about 50,000 ppm hexamethylenediamine, and about 500 ppm adipic acid. Finished polyamide pellets generated by the system have a yellowness index measured in accordance with ASTM D1925 of about 3.5. The total amount of recycled water entering the salt strike is 18.5 L/min, which is combined with 37.5 L/min of demineralized fresh water, with a recycle ratio of 0.5:1.

Approximately 0.6 Kg/day of gel is generated in the continuous polymerization system. The reactor recycle apparatus costs about 3*X/day to operate, plus the cost of condensing the steam of about 14*X/day. As compared to a corresponding process having no evaporator recycle, avoiding excess sewer discharge fines and using less demineralized fresh water saves about 30*X per day.

### Example 6

### Selective Removal of Impurities from Recycle Water with 1:1 Recycle Ratio with Rectification, No Heat Integration

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is condensed into liquid for recycling. Condensing 18.5 Kg/min of 100° C. steam into 18.5 L/min of aqueous 90° C. liquid requires about 43 MJ/min. Approximately 18.5 L/min of condensed water from the reactor is recycled back to the salt strike. The tubular reactor recycle apparatus and associated transfer piping is primarily stainless steel. After 3-months online, the purified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. Approximately 9.5 L/min of purified water from the evaporator (e.g., about 30 wt % of the total amount of water removed from the reaction mixture in the evaporator), which contains no impurities, is recycled back to the salt strike as well. The total amount of recycled water entering the salt strike is 28 L/min, which is combined with 28 L/min of demineralized fresh water, with a recycle ratio of 1:1.

Approximately 0.4 Kg/day of gel is generated in the continuous polymerization system. The reactor recycle apparatus costs about 4*X/day to operate, plus the cost of condensing the steam of about 14*X/day. As compared to a corresponding process having no evaporator recycle, avoiding excess sewer discharge fines and using less demineralized fresh water saves about 3*X per day.

### Example 7

### Selective Removal of Impurities from Recycle Water with Rectification, No Heat Integration

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is condensed into liquid for recycling. Condensing 18.5 Kg/min of 100° C. steam into 18.5 L/min of aqueous 90° C. liquid requires about 43 MJ/min. Approximately 18.5 L/min of condensed water from the reactor is recycled back to the salt strike. The tubular reactor recycle apparatus and associated transfer piping is primarily stainless steel. After 3-months online, the purified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. The total amount of recycled water entering the salt strike is 18.5 L/min, which is combined with 37.5 L/min of demineralized fresh water, with a recycle ratio of 0.5:1.

Approximately 0.4 Kg/day of gel is generated in the continuous polymerization system. The reactor recycle apparatus costs about 4*X/day to operate, plus the cost of condensing the steam of about 14*X/day. As compared to a corresponding process having no evaporator recycle, avoiding excess sewer discharge fines and using less demineralized fresh water saves about 30*X per day.

### Example 8

### Selective Removal of Impurities from Recycle Water with Rectification, No Heat Integration

The continuous polymerization process is performed. The vaporous material evaporated from the reaction mixture in the reactor exits the vents of the reactor and is directed to a 10 M tall 0.5 M diameter rectification column packed with Raschig rings. The vapour that exits the top of the column is condensed into liquid for recycling. Condensing 18.5 Kg/min of 100° C. steam into 18.5 L/min of aqueous 90° C. liquid requires about 43 MJ/min. Approximately 18.5 L/min of condensed water from the reactor is recycled back to the salt strike. The tubular reactor recycle apparatus and associated transfer piping is primarily stainless steel. After 3-months online, the purified water recycled to the salt strike contains about 1 ppm iron, about 0.5 ppm cobalt, about 10 ppm cyclopentanone, about 8 ppm hexamethyleneimine, about 5 ppm bis(hexamethylene)diamine, about 100 ppm hexamethylenediamine, and about 1 ppm adipic acid. Finished polyamide pellets generated by the system have a yellowness index measured in accordance with ASTM D1925 of about 1.4. The total amount of recycled water entering the salt strike is 18.5 L/min, which is combined with 37.5 L/min of demineralized fresh water, with a recycle ratio of 0.5:1.

Approximately 0.35 Kg/day of gel is generated in the continuous polymerization system. The reactor recycle apparatus costs about 16*X/day to operate, plus the cost of condensing the steam of about 14*X/day. As compared to a corresponding process having no evaporator recycle, avoiding excess sewer discharge fines and using less demineralized fresh water saves about 30*X per day.

### Example 9

### Selective Removal of Impurities from Recycle Water with Rectification and Filtration, No Heat Integration

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is condensed into liquid for recycling. The condensed liquid is cleaned by passing through a filter assembly containing a coarse filter (200 μm) in line with a first fine filter (50 μm). The first fine filter is in line with an activated carbon sorbent bed containing about 50 Kg of activated carbon sorbent. The water then passes through a second fine filter (5 μm). Condensing 18.5 Kg/min of 100° C. steam into 18.5 L/min of aqueous 90° C. liquid requires about 43 MJ/min. Approximately 18.5 L/min of condensed water from the reactor is recycled back to the salt strike. The tubular reactor recycle apparatus and associated transfer piping is primarily stainless steel. After 3-months online, the purified water recycled to the salt strike contains about 5 ppm iron, about 2 ppm cobalt, about 50 ppm cyclopentanone, about 40 ppm hexamethyleneimine, about 25 ppm bis(hexamethylene)diamine, about 2,500 ppm hexamethylenediamine, and about 25 ppm adipic acid. Finished polyamide pellets generated by the system have a yellowness index measured in accordance with ASTM D1925 of about 1.5. The total amount of recycled water entering the salt strike is 18.5 L/min, which is combined with 37.5 L/min of demineralized fresh water, with a recycle ratio of 0.5:1.

Approximately 0.35 Kg/day of gel is generated in the continuous polymerization system. The reactor recycle apparatus costs about 5*X/day to operate, plus the cost of condensing the steam of about 14*X/day. As compared to a corresponding process having no evaporator recycle, avoiding excess sewer discharge fines and using less demineralized fresh water saves about 30*X per day.

### Example 10

### Selective Removal of Impurities from Recycle Water, Recycle Ratio of 4:1, No Heat Integration

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is condensed into liquid for recycling. Condensing 18.5 Kg/min of 100° C. steam into 18.5 L/min of aqueous 90° C. liquid requires about 43 MJ/min. Approximately 18.5 L/min of condensed water from the reactor is recycled back to the salt strike. The tubular reactor recycle apparatus and associated transfer piping is primarily stainless steel. After 3-months online, the purified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. Approximately 26.3 L/min of purified water from the evaporator (e.g., about 82 wt % of the total water removed from the reaction mixture in the evaporator), which contains no impurities, is recycled back to the salt strike as well. The total amount of recycled water entering the salt strike is 44.8 L/min, which is combined with 11.2 L/min of demineralized fresh water, with a recycle ratio of 4:1.

Approximately 0.4 Kg/day of gel is generated in the continuous polymerization system. The reactor recycle apparatus costs about 5*X/day to operate, plus the cost of condensing the steam of about 14*X/day. As compared to a corresponding process having no evaporator recycle, avoiding excess sewer discharge fines and using less demineralized fresh water saves about 50*X per day.

### Example 11

### Selective Removal of Impurities from Recycle Water, Recycle Ratio of 14.1:1, No Heat Integration

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is condensed into liquid for recycling. Condensing 18.5 Kg/min of 100° C. steam into 18.5 L/min of aqueous 90° C. liquid requires about 43 MJ/min. Approximately 18.5 L/min of condensed water from the reactor is recycled back to the salt strike. The tubular reactor recycle apparatus and associated transfer piping is primarily stainless steel. After 3-months online, the purified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. Approximately 32 L/min of purified water from the evaporator (e.g., 100 wt % of the water removed from the reaction mixture in the evaporator), which contains no impurities, is recycled back to the salt strike as well. The total amount of recycled water entering the salt strike is 50.5 L/min, which is combined with 3.5 L/min of demineralized fresh water, with a recycle ratio of 14.4:1.

Approximately 0.4 Kg/day of gel is generated in the continuous polymerization system. The reactor recycle apparatus costs about 5*X/day to operate, plus the cost of condensing the steam of about 14*X/day. As compared to a corresponding process having no evaporator recycle, avoiding excess sewer discharge fines and using less demineralized fresh water saves about 60*X per day.

### Example 12

### Selective Removal of Impurities from Recycle Water, Carbon Steel Evaporator Recycle Apparatus with Rectification, No Heat Integration

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is condensed into liquid for recycling. Condensing 18.5 Kg/min of 100° C. steam into 18.5 L/min of aqueous 90° C. liquid requires about 43 MJ/min. Approximately 18.5 L/min of condensed water from the reactor is recycled back to the salt strike. The tubular reactor recycle apparatus and associated transfer piping is primarily carbon steel. After 3-months online, the purified water recycled to the salt strike contains about 100 ppm iron, about 50 ppm cobalt, about 500 ppm cyclopentanone, about 220 ppm hexamethyleneimine, about 200 ppm bis(hexamethylene)diamine, about 1,000 ppm hexamethylenediamine, and about 50 ppm adipic acid. Finished polyamide pellets generated by the system have a yellowness index measured in accordance with ASTM D1925 of about 1.8. The total amount of recycled water entering the salt strike is 18.5 L/min, which is combined with 37.5 L/min of demineralized fresh water, with a recycle ratio of 0.5:1.

Approximately 0.5 Kg/day of gel is generated in the continuous polymerization system. The reactor recycle apparatus costs about 4*X/day to operate, plus the cost of condensing the steam of about 14*X/day. As compared to a corresponding process having no evaporator recycle, avoiding excess sewer discharge fines and using less demineralized fresh water saves about 30*X per day.

### Example 13

### Selective Removal of Impurities from Recycle Water, Treated Carbon Steel Evaporator Recycle Apparatus with Rectification, No Heat Integration

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is condensed into liquid for recycling. Condensing 18.5 Kg/min of 100° C. steam into 18.5 L/min of aqueous 90° C. liquid requires about 43 MJ/min. Approximately 18.5 L/min of condensed water from the reactor is recycled back to the salt strike. The tubular reactor recycle apparatus and associated transfer piping is primarily carbon steel that has been treated with a combination of sodium dihydrogen orthophosphate, sodium benzoate, sodium nitrite, and sodium nitrate. After 3-months online, the purified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. The total amount of recycled water entering the salt strike is 18.5 L/min, which is combined with 37.5 L/min of demineralized fresh water, with a recycle ratio of 0.5:1.

Approximately 0.4 Kg/day of gel is generated in the continuous polymerization system. The reactor recycle apparatus costs about 4*X/day to operate, plus the cost of condensing the steam of about 14*X/day. However, over a period of about six months, the corrosion-control materials leach out of the carbon steel, partially losing their corrosion-controlling effect and contaminating the polyamide product. After six month the purified water recycled to the salt strike contains about 100 ppm iron, about 50 ppm cobalt, about 500 ppm cyclopentanone, about 220 ppm hexamethyleneimine, about 200 ppm bis(hexamethylene)diamine, about 1,000 ppm hexamethylenediamine, and about 50 ppm adipic acid. Finished polyamide pellets generated by the system have a yellowness index measured in accordance with ASTM D1925 of about 1.8. After six months, the gel formation rate is about 0.5 Kg/day. As compared to a corresponding process having no evaporator recycle, avoiding excess sewer discharge fines and using less demineralized fresh water saves about 30*X per day.

### Example 14

### Comparative. Heat Integration with Evaporator without Rectification

The continuous polymerization process is performed. The vaporous material evaporated from the reaction mixture in the reactor exits the vents of the reactor and is charged to a heat transfer apparatus to partially heat the evaporator. Condensing 18.5 Kg/min of 235° C. steam into 18.5 L/min aqueous liquid at about 130° C. (under pressure) transfers about 47 MJ/min to the evaporator. The condensed water is recycled back to the salt strike at a rate of about 18.5 L/min. The tubular reactor recycle apparatus, associated transfer piping, and evaporator heat transfer apparatus are primarily stainless steel. After 3-months online, the purified water recycled to the salt strike contains about 100 ppm iron, about 50 ppm cobalt, about 10,000 ppm cyclopentanone, about 8,000 ppm hexamethyleneimine, about 5,000 ppm bis(hexamethylene)diamine, about 100,000 ppm hexamethylenediamine, and about 1,000 ppm adipic acid. Finished polyamide pellets generated by the system have a yellowness index measured in accordance with ASTM D1925 of about 4. The total amount of recycled water entering the salt strike is 18.5 L/min, which is combined with 37.5 L/min of demineralized fresh water, with a recycle ratio of 0.5:1.

Approximately 1 Kg/day of gel is generated in the continuous polymerization system. The reactor recycle apparatus costs about X/day to operate. As compared to a corresponding process without heat transfer to the evaporator, transferring heat to the evaporator saves about 15.5*X/day. As compared to a corresponding process having no evaporator recycle, avoiding excess sewer discharge fines and using less demineralized fresh water saves about 30*X per day.

### Example 15

### Comparative. Heat Integration with Evaporator and Steam for Finisher without Rectification

The continuous polymerization process is performed. The vaporous material evaporated from the reaction mixture in the reactor exits the vents of the reactor and is used to at least partially drive a vacuum steam ejector which draws a vacuum on the downstream finisher. The vapour that exits the finisher is is charged to a heat transfer apparatus to partially heat the evaporator. Condensing 18.5 Kg/min of 235° C. steam into 18.5 L/min aqueous liquid at about 130° C. (under pressure) transfers about 47 MJ/min to the evaporator. The condensed water is recycled back to the salt strike at a rate of about 18.5 L/min. The tubular reactor recycle apparatus, associated transfer piping, and evaporator heat transfer apparatus are primarily stainless steel. After 3-months online, the purified water recycled to the salt strike contains about 100 ppm iron, about 50 ppm cobalt, about 10,000 ppm cyclopentanone, about 8,000 ppm hexamethyleneimine, about 5,000 ppm bis(hexamethylene)diamine, about 100,000 ppm hexamethylenediamine, and about 1,000 ppm adipic acid. Finished polyamide pellets generated by the system have a yellowness index measured in accordance with ASTM D1925 of about 4. The total amount of recycled water entering the salt strike is 18.5 L/min, which is combined with 37.5 L/min of demineralized fresh water, with a recycle ratio of 0.5:1.

Approximately 1 Kg/day of gel is generated in the continuous polymerization system. The reactor recycle apparatus costs about X/day to operate. As compared to a corresponding process without heat transfer to the evaporator, transferring heat to the evaporator saves about 15.5*X/day. Providing 18.5 Kg/min steam to the finisher saves about 20*X/day over a corresponding process not having a steam recycle to the finisher. As compared to a corresponding process having no evaporator recycle, avoiding excess sewer discharge fines and using less demineralized fresh water saves about 30*X per day.

### Example 16

### Rectification with Heat Integration with Evaporator

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is charged to a heat transfer apparatus to partially heat the evaporator. Condensing 18.5 Kg/min of 130° C. steam under pressure into 18.5 L/min aqueous liquid at 130° C. (under pressure) transfers about 43 MJ/min to the evaporator. Approximately 18.5 L/min of condensed water from the reactor is recycled back to the salt strike. The tubular reactor recycle apparatus, associated transfer piping, and evaporator heat transfer apparatus are primarily stainless steel. After 3-months online, the purified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. The total amount of recycled water entering the salt strike is 18.5 L/min, which is combined with 37.5 L/min of demineralized fresh water, with a recycle ratio of 0.5:1.

Approximately 0.4 Kg/day of gel is generated in the continuous polymerization system. The reactor recycle apparatus costs about 4*X/day to operate. As compared to a corresponding process without heat transfer to the evaporator, transferring heat to the evaporator saves about 15*X/day. As compared to a corresponding process having no evaporator recycle, avoiding excess sewer discharge fines and using less demineralized fresh water saves about 30*X per day.

### Example 17

### Rectification with Heat Integration with Evaporator and Steam for Finisher

The continuous polymerization process is performed. The vaporous material evaporated from the reaction mixture in the reactor exits the vents of the reactor and is directed to a 3 M tall 0.5 M diameter rectification column packed with Raschig rings. The steam that exits the column is used to at least partially drive a vacuum steam ejector which draws a vacuum on the downstream finisher. The vapour that exits the finisher is charged to a heat transfer apparatus to partially heat the evaporator. Condensing 18.5 Kg/min of 130° C. steam under pressure into 18.5 L/min aqueous liquid at 130° C. (under pressure) transfers about 43 MJ/min to the evaporator. Approximately 18.5 L/min of condensed water from the reactor is recycled back to the salt strike. The tubular reactor recycle apparatus, associated transfer piping, and evaporator heat transfer apparatus are primarily stainless steel. After 3-months online, the purified water recycled to the salt strike contains about 10 ppm iron, about 5 ppm cobalt, about 100 ppm cyclopentanone, about 80 ppm hexamethyleneimine, about 50 ppm bis(hexamethylene)diamine, about 5,000 ppm hexamethylenediamine, and about 50 ppm adipic acid. Finished polyamide pellets generated by the system have a yellowness index measured in accordance with ASTM D1925 of about 1.5. The total amount of recycled water entering the salt strike is 18.5 L/min, which is combined with 37.5 L/min of demineralized fresh water, with a recycle ratio of 0.5:1.

Approximately 0.4 Kg/day of gel is generated in the continuous polymerization system. The reactor recycle apparatus costs about 4*X/day to operate. As compared to a corresponding process without heat transfer to the evaporator, transferring heat to the evaporator saves about 15*X/day. Providing 18.5 Kg/min steam to the finisher saves about 20*X/day over a corresponding process not having a steam recycle to the finisher. As compared to a corresponding process having no evaporator recycle, avoiding excess sewer discharge fines and using less demineralized fresh water saves about 30*X per day.

### Example 18

### Comparative. Rectification with Heat Integration with Evaporator, Carbon Steel Apparatus

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is charged to a heat transfer apparatus to partially heat the evaporator. Condensing 18.5 Kg/min of 130° C. steam under pressure into 18.5 L/min aqueous liquid at 130° C. (under pressure) transfers about 43 MJ/min to the evaporator. Approximately 18.5 L/min of condensed water from the reactor is recycled back to the salt strike. The tubular reactor recycle apparatus, associated transfer piping, and evaporator heat transfer apparatus are primarily carbon steel. After 3-months online, the purified water recycled to the salt strike contains about 100 ppm iron, about 50 ppm cobalt, about 500 ppm cyclopentanone, about 220 ppm hexamethyleneimine, about 200 ppm bis(hexamethylene)diamine, about 1,000 ppm hexamethylenediamine, and about 50 ppm adipic acid. Finished polyamide pellets generated by the system have a yellowness index measured in accordance with ASTM D1925 of about 1.8. The total amount of recycled water entering the salt strike is 18.5 L/min, which is combined with 37.5 L/min of demineralized fresh water, with a recycle ratio of 0.5:1.

Approximately 3 Kg/day of gel is generated in the continuous polymerization system. The reactor recycle apparatus costs about 4*X day to operate. As compared to a corresponding process without heat transfer to the evaporator, transferring heat to the evaporator saves about 15*X/day. As compared to a corresponding process having no evaporator recycle, avoiding excess sewer discharge fines and using less demineralized fresh water saves about 30*X per day.

### Example 19

### Rectification with Heat Integration with Evaporator and Filtration, Carbon Steel Apparatus

The continuous polymerization process is performed. The vaporous material evaporated from the reaction mixture in the reactor exits the vents of the reactor and is directed to a 3 M tall 0.5 M diameter rectification column packed with Raschig rings. The vapour that exits the top of the column is charged to a heat transfer apparatus to partially heat the evaporator. Condensing 18.5 Kg/min of 130° C. steam under pressure into 18.5 L/min aqueous liquid at 130° C. (under pressure) transfers about 43 MJ/min to the evaporator. The condensed water is cleaned by passing through a filter assembly containing a coarse filter (200 μm) in line with a first fine filter (50 μm). The first fine filter is in line with an activated carbon sorbent bed containing about 50 Kg of activated carbon sorbent. The water then passes through a second fine filter (5 μm). Approximately 18.5 L/min of condensed water from the reactor is recycled back to the salt strike. The tubular reactor recycle apparatus, associated transfer piping, and evaporator heat transfer apparatus are primarily carbon steel. After 3-months online, the purified water recycled to the salt strike contains about 60 ppm iron, about 70 ppm cobalt, about 300 ppm cyclopentanone, about 150 ppm hexamethyleneimine, about 60 ppm bis(hexamethylene)diamine, about 500 ppm hexamethylenediamine, and about 50 ppm adipic acid. Finished polyamide pellets generated by the system have a yellowness index measured in accordance with ASTM D1925 of about 1.6. The total amount of recycled water entering the salt strike is 18.5 L/min, which is combined with 37.5 L/min of demineralized fresh water, with a recycle ratio of 0.5:1.

Approximately 0.4 Kg/day of gel is generated in the continuous polymerization system. The reactor recycle apparatus costs about 4*X/day to operate. As compared to a corresponding process without heat transfer to the evaporator, transferring heat to the evaporator saves about 15*X/day. As compared to a corresponding process having no evaporator recycle, avoiding excess sewer discharge fines and using less demineralized fresh water saves about 30*X per day.

Embodiments of the invention described and claimed herein are not to be limited in scope by the specific embodiments herein disclosed, since these embodiments are intended as illustration of several aspects of the disclosure. Any equivalent embodiments are intended to be within the scope of this disclosure. Indeed, various modifications of the embodiments in addition to those shown and described herein will become apparent to those skilled in the art from the foregoing description. Such modifications are also intended to fall within the scope of the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein. In addition, where features or aspects of the invention are described in terms of Markush groups, those skilled in the art will recognize that the invention is also thereby described in terms of any individual member or subgroup of members of the Markush group.

As used herein and in the appended claims, the singular forms “a,” “an,” and “the” include plural reference unless the context clearly dictates otherwise. Thus, for example, a reference to “a reactor” includes a plurality of reactors, such as in a series of reactors. In this document, the term “or” is used to refer to a nonexclusive or, such that “A or B” includes “A but not B,” “B but not A,” and “A and B,” unless otherwise indicated.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

All publications, including non-patent literature (e.g., scientific journal articles), patent application publications, and patents mentioned in this specification are incorporated by reference as if each were specifically and individually indicated to be incorporated by reference.

The present invention provides for the following embodiments, the numbering of which is not to be construed as designating levels of importance:

Statement 1 provides a method for recovering water from a condensation reaction of at least one carboxylic acid and at least one diamine to make polyamide comprising: obtaining, from an evaporator, an aqueous mixture comprising a partially polymerized polyamide and at least one of a carboxylic acid and diamine; passing the aqueous mixture through a tubular reactor comprising subjecting the aqueous mixture to a temperature and pressure sufficient to further polymerize the partially polymerized polyamide by condensation of the carboxylic acid and diamine, thereby producing water having a substantially gaseous phase; passing the water having a substantially gaseous phase into a rectification column thereby removing one or more of a diamine, a carboxylic acid and polyamide to provide purified water having a substantially gaseous phase; and condensing the purified water having a substantially gaseous phase into purified water having a substantially liquid phase.

Statement 2 provides the method of Statement 1 further comprising removing at least one impurity from at least one of the purified water having a substantially liquid phase and the water having a substantially gaseous phase, wherein the impurity comprises at least one of a gelation-causing material and a polyamide-degrading material.

Statement 3 provides the method of Statement 2, wherein the impurity comprises iron.

Statement 4 provides the method of Statement 2, wherein the impurity comprises at least one chosen from iron, cobalt, titanium, manganese, magnesium, silica, cyclopentanone, hexamethyleneimine, and bis(hexamethylene)triamine.

Statement 5 provides the method of any one of Statements 1-4 further comprising returning the water having a substantially liquid phase to a reservoir or to a polyamide production reactor.

Statement 6 provides the method of Statement 5, wherein the method further comprises operating at a water recycle ratio of at least 0.2:1.

Statement 7 provides the method of any one of Statements 1-6 further comprising reusing the purified water having a substantially liquid phase.

Statement 8 provides the method of Statement 7, wherein reusing the purified water having a substantially liquid phase comprises returning the purified water having a substantially liquid phase to one or more components of a polyamide synthesis process.

Statement 9 provides the method of any one of Statements 1-8, wherein the rectification column comprises a rectifying zone.

Statement 10 provides the method of any one of Statements 1-9, wherein the rectification column comprises one or more condensers.

Statement 11 provides the method of Statement 10, wherein the one or more condensers transfer heat to one or more components of the polyamide synthesis process.

Statement 12 provides the method of any one of Statements 1-11, wherein condensing the purified water having a substantially gaseous phase into purified water having a substantially liquid phase comprises condensing at least 80% of the water having a substantially gaseous phase.

Statement 13 provides the method of any one of Statements 1-12 further comprising passing the purified water having a substantially liquid phase through a filter or absorption assembly comprising at least one activated carbon sorbent bed to provide substantially purified water having a substantially liquid phase.

Statement 14 provides the method of Statement 13, wherein the substantially purified water having a substantially liquid phase is sufficiently pure to be transformed and used as a source of steam in the polyamide synthesis process.

Statement 15 provides the method of any one of Statements 1-14, wherein the water having a substantially gaseous phase is sufficiently pure to be used as a source of steam in the polyamide synthesis process.

Statement 16 provides the method of any one of Statements 1-15 further comprising reusing the one or more of a diamine, a carboxylic acid or polyamide removed in the rectification column.

Statement 17 provides the method of Statement 16, wherein reusing the one or more of a diamine, a carboxylic acid or polyamide removed in the rectification column comprises returning the one or more of a diamine, a carboxylic acid or polyamide removed in the rectification column to one or more components of a polyamide synthesis process.

Statement 18 provides the method of Statement 17, wherein the one or more components of a polyamide synthesis process comprises at least one of an evaporator, the tubular reactor and a salt strike.

Statement 19 provides the method of any one of Statements 1-18, wherein the tubular reactor has a length of from about 50 to about 300 meters.

Statement 20 provides the method of any one of Statements 1-18, wherein the tubular reactor has a length of from about 75 to about 125 meters.

Statement 21 provides the method of any one of Statements 1-20, wherein the tubular reactor has an inner diameter of about 10 cm to about 80 cm.

Statement 22 provides the method of any one of Statements 1-21, wherein the tubular reactor further comprises a jacket.

Statement 23 provides the method of Statement 1, wherein the ratio of length to diameter of the tubular reactor is about 50 to about 2500.

Statement 24 provides the method of any one of Statements 1-23, wherein the ratio of length to diameter of the tubular reactor is about 100 to about 500.

Statement 25 provides the method of any one of Statements 1-24, wherein the tubular reactor further comprises vents along its length.

Statement 26 provides the method of Statement 25, wherein the tubular reactor comprises about 5 to about 50 vents.

Statement 27 provides the method of Statement 25, wherein the tubular reactor comprises about 10 to about 25 vents.

Statement 28 provides the method of any one of Statements 25-27, wherein the tubular reactor comprises an average of about 1 vent per about 2 meters to about 15 meters along the length of the tubular reactor.

Statement 29 provides the method of any one of Statements 25-28, wherein the tubular reactor comprises an average of about 1 vent per about 3 meters to about 9 meters along the length of the tubular reactor.

Statement 30 provides the method of any one of Statements 25-29, wherein the tubular reactor comprises about 2 meters to about 15 meters of average spacing between vents along the length of the tubular reactor.

Statement 31 provides the method of any one of Statements 25-30, the tubular reactor comprises about 3 meters to about 9 meters of average spacing between vents along the length of the tubular reactor.

Statement 32 provides the method of any one of Statements 1-31, wherein the tubular reactor comprises a length of about 75 to about 125 meters, the tubular reactor comprises an inner diameter of about 25 cm to about 60 cm, the tubular reactor comprises a length/diameter (L/ID) of about 100 to about 500, and wherein the tubular reactor comprises about 10 to about 25 vents along its length.

Statement 33 provides the method of any one of Statements 1-32, wherein the aqueous mixture and the partially polymerized polyamide comprise monomers of a C₄-C₁₈ α,ω-dicarboxylic acid.

Statement 34 provides the method of Statement 33, wherein the dicarboxylic acid is a C₄-C₁₀ α,ω-dicarboxylic acid.

Statement 35 provides the method of any one of Statements 33-34, wherein the dicarboxylic acid is a C₄-C₈ α,ω-dicarboxylic acid.

Statement 36 provides the method of any one of Statements 33-35, wherein the dicarboxylic acid is adipic acid.

Statement 37 provides the method of any one of Statements 1-36, wherein the aqueous mixture and the partially polymerized polyamide comprise monomers of a C₄-C₁₈ α,ω-diamine.

Statement 38 provides the method of Statement 37, wherein the diamine is a C₄-C₁₀ α,ω-diamine.

Statement 39 provides the method of any one of Statements 37-38, wherein the diamine is a C₄-C₈ α,ω-diamine.

Statement 40 provides the method of any one of Statements 37-39, wherein the diamine is hexamethylenediamine.

Statement 42 provides the method of any one of Statements 1-40, wherein the polyamide is nylon 6,6.

Statement 43 provides a method for recovering water from a nylon 6,6 synthesis process comprising: obtaining, from an evaporator, an aqueous mixture comprising a partially polymerized nylon 6,6 and hexamethylenediamine; passing the aqueous mixture through a tubular reactor while subjecting the aqueous mixture to a temperature and pressure sufficient to further polymerize the partially polymerized nylon 6,6, thereby producing water having a substantially gaseous phase; passing the water having a substantially gaseous phase into a rectification column thereby removing at least a portion of any hexamethylenediamine present in the water having a substantially gaseous phase, to provide purified water having a substantially gaseous phase; and condensing the purified water having a substantially gaseous phase into purified water having a substantially liquid phase.

Statement 44 provides a method for recovering water from a condensation reaction of at least one carboxylic acid and at least one diamine to make polyamide comprising: obtaining, from an evaporator, an aqueous mixture comprising a partially polymerized polyamide and at least one of a carboxylic acid and diamine; reacting the aqueous mixture in a tubular reactor comprising subjecting the aqueous mixture to a temperature and pressure sufficient to further polymerize the partially polymerized polyamide by condensation of the carboxylic acid and diamine, thereby producing water having a substantially gaseous phase; rectifying the water having a substantially gaseous phase in a rectification column comprising a rectifying zone thereby removing one or more of a diamine, a carboxylic acid and a diamine to provide purified water having a substantially gaseous phase; optionally determining whether the water having a substantially gaseous phase comprises carboxylic acid or diamine in excess or the desired stoichiometric balance and injecting carboxylic acid or diamine into the rectifying zone; and condensing the purified water having a substantially gaseous phase into purified water having a substantially liquid phase.

Statement 45 provides a system comprising: a tubular reactor configured to further polymerize a partially polymerized polyamide, thereby producing water having a substantially gaseous phase; a rectification column, in fluid communication with the tubular reactor, configured to remove one or more of a diamine, a carboxylic acid and polyamide to provide purified water having a substantially gaseous phase; a condensation assembly, in fluid communication with the rectification column, configured to receive the water having a substantially gaseous phase and transform the water having a substantially gaseous phase into water having a substantially liquid phase; and a conduit network configured to return the water having a substantially liquid phase to at least one component of a polyamide production system.

Statement 46 provides an apparatus for manufacturing a polyamide comprising: a tubular reactor configured to further polymerize a partially polymerized polyamide, thereby producing water having a substantially gaseous phase; a rectification column, in fluid communication with the tubular reactor, configured to remove one or more of a diamine, a carboxylic acid and polyamide to provide purified water having a substantially gaseous phase; a condensation assembly, in fluid communication with the rectification column, configured to receive the water having a substantially gaseous phase and transform the water having a substantially gaseous phase into water having a substantially liquid phase; and a conduit network configured to return the water having a substantially liquid phase to at least one component of a polyamide production system.

Statement 47 provides the apparatus of Statement 44, wherein the apparatus is configure to remove at least one impurity from at least one of the purified water having a substantially liquid phase and the water having a substantially gaseous phase, wherein the impurity comprises at least one of a gelation-causing material and a polyamide-degrading material.

Statement 48 provides the apparatus of Statement 47, wherein the impurity comprises iron.

Statement 49 provides the apparatus of any one of Statements 46-48, wherein the impurity comprises at least one chosen from iron, cobalt, manganese, magnesium, titanium, silica, cyclopentanone, hexamethyleneimine, and bis(hexamethylene)triamine.

Statement 50 provides the apparatus of any one of Statements 44-49, wherein the apparatus is configured to return the water having a substantially liquid phase to a reservoir or to the tubular reactor.

Statement 51 provides the apparatus of Statement 50, wherein the apparatus operates at a water recycle ratio of at least 0.2:1.

Statement 52 provides the apparatus of any one of Statements 44-51, wherein the apparatus is configured to reuse the purified water having a substantially liquid phase.

Statement 53 provides the apparatus of Statement 52, wherein reusing the purified water having a substantially liquid phase comprises returning the purified water having a substantially liquid phase to one or more components of a polyamide synthesis process.

Statement 54 provides the apparatus of any one of Statements 44-53, wherein the rectification column comprises a rectifying zone.

Statement 55 provides the apparatus of Statement 54, wherein the rectification column comprises one or more condensers.

Statement 56 provides the apparatus of Statement 55, wherein the one or more condensers are configured to transfer heat to one or more components of the polyamide synthesis process.

Statement 57 provides the apparatus of any one of Statements 44-56, wherein the condensation assembly is configured to transform at least 80% of the water having a substantially gaseous phase into water having a substantially liquid phase.

Statement 58 provides the apparatus of any one of Statements 44-57 further comprising a filter or absorption assembly through which the water having a substantially liquid phase passes through, wherein the filter or absorption assembly comprises at least one activated carbon sorbent bed and the filter or absorption assembly provides substantially purified water having a substantially liquid phase.

Statement 59 provides the apparatus of Statement 58, wherein the substantially purified water having a substantially liquid phase is sufficiently pure to be transformed and used as a source of steam in the polyamide synthesis process.

Statement 60 provides the apparatus of any one of Statements 44-59, wherein the water having a substantially gaseous phase is sufficiently pure to be used as a source of steam in the polyamide synthesis process.

Statement 61 provides the apparatus of any one of Statements 44-60, wherein the one or more of a diamine, a carboxylic acid or polyamide removed in the rectification column are reused.

Statement 62 provides the apparatus of Statement 61, wherein reusing the one or more of a diamine, a carboxylic acid or polyamide removed in the rectification column comprises returning the one or more of a diamine, a carboxylic acid or polyamide removed in the rectification column to one or more components of a polyamide production system.

Statement 63 provides the apparatus of Statement 62, wherein the one or more components of a polyamide production system comprises at least one of an evaporator, the tubular reactor and a salt strike.

Statement 64 provides the apparatus of any one of Statements 44-63, wherein the tubular reactor has a length of from about 50 to about 300 meters.

Statement 65 provides the apparatus of any one of Statements 44-64, wherein the tubular reactor has a length of from about 75 to about 125 meters.

Statement 66 provides the apparatus of any one of Statements 44-65, wherein the tubular reactor has an inner diameter of about 10 cm to about 80 cm.

Statement 67 provides the apparatus of any one of Statements 44-66, wherein the tubular reactor further comprises a jacket.

Statement 68 provides the apparatus of any one of Statements 44-67, wherein the ratio of length to diameter of the tubular reactor is about 50 to about 2500.

Statement 69 provides the apparatus of any one of Statements 44-68, wherein the ratio of length to diameter of the tubular reactor is about 100 to about 500.

Statement 70 provides the apparatus of any one of Statements 44-69, wherein the tubular reactor further comprises vents along its length.

Statement 71 provides the apparatus of Statement 70, wherein the tubular reactor comprises about 5 to about 50 vents.

Statement 72 provides the apparatus of Statement 70, wherein the tubular reactor comprises about 10 to about 25 vents.

Statement 73 provides the apparatus of any one of Statements 69-72, wherein the tubular reactor comprises an average of about 1 vent per about 2 meters to about 15 meters along the length of the tubular reactor.

Statement 74 provides the apparatus of any one of Statements 69-73, wherein the tubular reactor comprises an average of about 1 vent per about 3 meters to about 9 meters along the length of the tubular reactor.

Statement 75 provides the apparatus of any one of Statements 69-74, wherein the tubular reactor comprises about 2 meters to about 15 meters of average spacing between vents along the length of the tubular reactor.

Statement 76 provides the apparatus of any one of Statements 69-75, the tubular reactor comprises about 3 meters to about 9 meters of average spacing between vents along the length of the tubular reactor.

Statement 77 provides the apparatus of any one of Statements 44-76, wherein the tubular reactor comprises a length of about 75 to about 125 meters, the tubular reactor comprises an inner diameter of about 25 cm to about 60 cm the tubular reactor comprises a length/diameter (L/ID) of about 100 to about 500, and wherein the tubular reactor comprises about 10 to about 25 vents along its length.

Statement 78 provides the apparatus of any one of Statements 44-77, wherein the partially polymerized polyamide comprise monomers of a C₄-C₁₈ α,ω-dicarboxylic acid.

Statement 79 provides the apparatus of Statement 78, wherein the dicarboxylic acid is a C₄-C₁₀ α,ω-dicarboxylic acid.

Statement 80 provides the apparatus of any one of Statements 78-79, wherein the dicarboxylic acid is a C₄-C₈ α,ω-dicarboxylic acid.

Statement 81 provides the apparatus of any one of Statements 78-79, wherein the dicarboxylic acid is adipic acid.

Statement 82 provides the apparatus of any one of Statements 44-81, wherein the partially polymerized polyamide comprise monomers of a C₄-C₁₈ α,ω-diamine.

Statement 83 provides the apparatus of Statement 82, wherein the diamine is a C₄-C₁₀ α,ω-diamine.

Statement 84 provides the apparatus of any one of Statements 82-83, wherein the diamine is a C₄-C₈ α,ω-diamine.

Statement 85 provides the apparatus of any one of Statements 82-84, wherein the diamine is hexamethylenediamine.

Statement 86 provides the apparatus of any one of Statements 44-85, wherein the polyamide is nylon 6,6.

1. A method for recovering water from a condensation reaction of at least one carboxylic acid and at least one diamine to make polyamide comprising:
obtaining, from an evaporator, an aqueous mixture comprising a partially polymerized polyamide and at least one of a carboxylic acid and diamine;
passing the aqueous mixture through a tubular reactor comprising subjecting the aqueous mixture to a temperature and pressure sufficient to further polymerize the partially polymerized polyamide by condensation of the carboxylic acid and diamine, thereby producing water having a substantially gaseous phase;
passing the water having a substantially gaseous phase into a rectification column thereby removing one or more of a diamine, a carboxylic acid and polyamide to provide purified water having a substantially gaseous phase; and
condensing the purified water having a substantially gaseous phase into purified water having a substantially liquid phase.

2. The method of claim 1 further comprising removing at least one impurity from at least one of the purified water having a substantially liquid phase and the water having a substantially gaseous phase, wherein the impurity comprises at least one of a gelation-causing material and a polyamide-degrading material.

3. The method of claim 2, wherein the impurity comprises iron.

4. The method of claim 2, wherein the impurity comprises at least one chosen from iron, cobalt, manganese, magnesium, titanium, silica, cyclopentanone, hexamethyleneimine, and bis(hexamethylene)triamine.

5. The method of claim 1, further comprising returning the water having a substantially liquid phase to a reservoir or to a polyamide production reactor.

6. The method of claim 5, wherein the method further comprises operating at a water recycle ratio of at least 0.2:1.

7. The method of claim 1 further comprising reusing the purified water having a substantially liquid phase.

8. The method of claim 1, wherein the rectification column comprises a rectifying zone.

9. The method of claim 1, wherein the rectification column comprises one or more condensers.

10. The method of claim 9, wherein the one or more condensers transfer heat to one or more components of the polyamide synthesis process.

11. The method of claim 1, wherein condensing the purified water having a substantially gaseous phase into purified water having a substantially liquid phase comprises condensing at least 80% of the water having a substantially gaseous phase.

12. The method of claim 1 further comprising passing the purified water having a substantially liquid phase through a filter or absorption assembly comprising at least one activated carbon sorbent bed to provide substantially purified water having a substantially liquid phase.

13. The method of claim 12, wherein the substantially purified water having a substantially liquid phase is sufficiently pure to be transformed and used as a source of steam in the polyamide synthesis process.

14. The method of claim 1, wherein the water having a substantially gaseous phase is sufficiently pure to be used as a source of steam in the polyamide synthesis process.

15. The method of claim 1 further comprising reusing the one or more of a diamine, a carboxylic acid or polyamide removed in the rectification column.

16. The method of claim 15, wherein reusing the one or more of a diamine, a carboxylic acid or polyamide removed in the rectification column comprises returning the one or more of a diamine, a carboxylic acid or polyamide removed in the rectification column to one or more components of a polyamide synthesis process.

17. The method of claim 16, wherein the one or more components of a polyamide synthesis process comprises at least one of an evaporator, the tubular reactor, and a salt strike.

18. The method of claim 1, wherein the polyamide is nylon 6,6.

19. A system comprising:
a tubular reactor configured to further polymerize a partially polymerized polyamide, thereby producing water having a substantially gaseous phase;
a rectification column, in fluid communication with the tubular reactor, configured to remove one or more of a diamine, a carboxylic acid and polyamide to provide purified water having a substantially gaseous phase;
a condensation assembly, in fluid communication with the rectification column, configured to receive the water having a substantially gaseous phase and transform the water having a substantially gaseous phase into water having a substantially liquid phase; and
a conduit network configured to return the water having a substantially liquid phase to at least one component of a polyamide production system.

20. An apparatus for manufacturing a polyamide comprising:
a tubular reactor configured to further polymerize a partially polymerized polyamide, thereby producing water having a substantially gaseous phase;
a rectification column, in fluid communication with the tubular reactor, configured to remove one or more of a diamine, a carboxylic acid and polyamide to provide purified water having a substantially gaseous phase;
a condensation assembly, in fluid communication with the rectification column, configured to receive the water having a substantially gaseous phase and transform the water having a substantially gaseous phase into water having a substantially liquid phase; and
a conduit network configured to return the water having a substantially liquid phase to at least one component of a polyamide production system.
